(19) United States
(12) Patent Application Publication
(10) Pub. No.: US 2026/0221149 A1
(43) Pub. Date: Jul. 30, 2026

(54) SPEECH EXTRACTION METHOD

(71) Applicant: Tencent Technology (Shenzhen) Company Limited, Shenzhen (CN)

(72) Inventors: He ZHAO, Shenzhen (CN); Hangting CHEN, Shenzhen (CN); Jianwei YU, Shenzhen (CN); Chao WENG, Shenzhen (CN)

(73) Assignee: Tencent Technology (Shenzhen) Company Limited, Shenzhen (CN)

(21) Appl. No.: 19/574,043

(22) Filed: Mar. 20, 2026

Related U.S. Application Data
(63) Continuation of application No. PCT/CN2024/127398, filed on Oct. 25, 2024.

(30) Foreign Application Priority Data
Nov. 29, 2023 (CN) 202311626816.0

(51) Int. Cl. G10L 21/0272; G10L 17/02; G10L 17/06; G10L 17/18; G10L 21/0208

(52) U.S. Cl. CPC G10L 21/0272; G10L 17/02; G10L 17/06; G10L 21/0208; G10L 17/18; G10L 2021/02087

(57) ABSTRACT

In a speech extraction method, a target object feature vector is extracted from a reference speech signal of a target object. In the method, a target object activity probability is generated through a combination of a speaker encoder and a first speech extraction model based on a mixed speech signal and the target object feature vector. In the method, an extracted speech signal is generated through a second speech extraction model based on the mixed speech signal and the target object feature vector. In the method, a target speech signal corresponding to the target object for audio output is obtained based on the target object activity probability and at least one of the extracted speech signal and the mixed speech signal.

### RELATED APPLICATIONS

The present application is a continuation of International Application No. PCT/CN2024/127398, filed on Oct. 25, 2024, which claims priority to Chinese Patent Application No. 202311626816.0, filed on Nov. 29, 2023. The entire disclosures of the prior applications are hereby incorporated by reference.

### FIELD OF THE TECHNOLOGY

This disclosure relates to the field of artificial intelligence, including a speech extraction method and apparatus, an electronic device, a computer-readable storage medium, and a computer program product.

### BACKGROUND OF THE DISCLOSURE

Artificial intelligence (AI) may correspond to a theory, a method, a technology, and an application system that uses a digital computer or a machine controlled by the digital computer to simulate, extend, and expand human intelligence, so as to sense an environment, obtain knowledge, and obtain an optimal result by using the knowledge. Artificial intelligence technologies are a comprehensive subject, relate to a wide range of fields, and have both technologies at a hardware level and technologies at a software level. Artificial intelligence software technologies in many cases include several major directions, such as computer vision technologies, speech processing technologies, natural language processing technologies, and machine learning/deep learning.

Currently, speech technologies have been widely applied. Key technologies of the speech technologies include automatic speech recognition (ASR) technologies, text to speech (TTS) technologies, and voiceprint recognition technologies. A development direction of human-computer interaction in the future is to enable a computer to listen, see, speak, and feel, where speech may become one of the most promising human-computer interaction modes in the future. During voiceprint recognition, target speaker extraction (TSE) is to extract speech delivered by a target speaker from a mixed speech signal with noise and interfering speech by using registered speech information of the target speaker. In some applications, a target speaker extraction method may have a poor extraction result on a mixed speech signal in which the speech signals delivered by a plurality of speakers exist, the speech signal delivered by a target speaker is absent, and an overlap rate of the speech signal delivered by the target speaker is low. Therefore, a target speaker extraction method that can effectively process such mixed speech signal is required.

### SUMMARY

Embodiments of this disclosure provide a speech extraction method and apparatus, an electronic device, a computer-readable storage medium, and a computer program product.

An embodiment of this disclosure provides a speech extraction method. In the method, a target object feature vector is extracted from a reference speech signal of a target object. In the method, a target object activity probability of the target object is generated by processing circuitry through a combination of a speaker encoder and a first speech extraction model based on a mixed speech signal and the target object feature vector, the first speech extraction model including at least one converter block, and the converter block including a multi-head self-attention layer and a gated recurrent unit layer. In the method, an extracted speech signal is generated by the processing circuitry through a second speech extraction model based on the mixed speech signal and the target object feature vector, the second speech extraction model being configured to extract a target object mask vector of the target object based on the target object feature vector and to obtain the extracted speech signal based on the target object mask vector. In the method, a target speech signal corresponding to the target object for audio output is obtained based on the target object activity probability and at least one of the extracted speech signal and the mixed speech signal.

An embodiment of this disclosure provides a speech extraction apparatus that includes processing circuitry. The processing circuitry is configured to extract a target object feature vector from a reference speech signal of a target object. The processing circuitry is configured to generate a target object activity probability of the target object through a combination of a speaker encoder and a first speech extraction model based on a mixed speech signal and the target object feature vector, the first speech extraction model including at least one converter block, and the converter block including a multi-head self-attention layer and a gated recurrent unit layer. The processing circuitry is configured to generate an extracted speech signal through a second speech extraction model based on the mixed speech signal and the target object feature vector, the second speech extraction model being configured to extract a target object mask vector of the target object based on the target object feature vector and to obtain the extracted speech signal based on the target object mask vector. The processing circuitry is configured to obtain a target speech signal corresponding to the target object for audio output based on the target object activity probability and at least one of the extracted speech signal and the mixed speech signal.

An embodiment of this disclosure provides a non-transitory computer-readable storage medium storing instructions, which when executed by a processor, cause the processor to perform a speech extraction method. In the method, a target object feature vector is extracted from a reference speech signal of a target object. In the method, a target object activity probability of the target object is generated through a combination of a speaker encoder and a first speech extraction model based on a mixed speech signal and the target object feature vector, the first speech extraction model including at least one converter block, and the converter block including a multi-head self-attention layer and a gated recurrent unit layer. In the method, an extracted speech signal is generated through a second speech extraction model based on the mixed speech signal and the target object feature vector, the second speech extraction model being configured to extract a target object mask vector of the target object based on the target object feature vector and to obtain the extracted speech signal based on the target object mask vector. In the method, a target speech signal corresponding to the target object for audio output is obtained based on the target object activity probability and at least one of the extracted speech signal and the mixed speech signal.

An embodiment of this disclosure provides a speech extraction method, the method being executed by the electronic device, and including: extracting a target object feature vector from a reference speech signal of a target object; generating a first speech signal of the target object by using a first speech extraction model based on a to-be-recognized mixed speech signal and the target object feature vector, the first speech extraction model including at least one converter block, and the converter block including a multi-head self-attention layer and a gated recurrent unit layer; generating a second speech signal of the target object by using a second speech extraction model based on the mixed speech signal and the target object feature vector, the second speech extraction model being configured to extract a target object mask vector of the target object from the mixed speech signal; and determining a target speech signal of the target object based on at least one of the first speech signal and the second speech signal.

An embodiment of this disclosure provides a speech extraction apparatus, including: a feature vector extraction unit, configured to extract a target object feature vector from a reference speech signal of a target object; and a target speech signal generation unit, configured to generate a first speech signal of the target object by using a first speech extraction model based on a to-be-recognized mixed speech signal and the target object feature vector, the first speech extraction model including at least one converter block, and the converter block including a multi-head self-attention layer and a gated recurrent unit layer; generate a second speech signal of the target object by using a second speech extraction model based on the mixed speech signal and the target object feature vector, the second speech extraction model being configured to extract a target object mask vector of the target object from the mixed speech signal; and determine a target speech signal of the target object based on at least one of the first speech signal and the second speech signal.

An embodiment of this disclosure provides an electronic device, including: processing circuitry (e.g., one or more processors); and one or more memories (e.g., including a non-transitory computer-readable storage medium), having computer-readable instructions stored therein, the computer-readable instructions, when executed by the one or more processors, enabling the one or more processors to perform the foregoing method.

An embodiment of this disclosure provides a non-transitory computer-readable storage medium, having computer-readable instructions stored therein, the computer-readable instructions, when executed by processing circuitry (e.g., a processor), enabling the processor to perform the foregoing method.

An embodiment of this disclosure provides a computer program product, including computer-readable instructions, the computer-readable instructions, when executed by processing circuitry (e.g., a processor), enabling the processor to perform the foregoing method.

In some embodiments of this disclosure, the at least one converter block including the multi-head self-attention sub-layer and the gated recurrent sub-layer is introduced into the first speech extraction model, so that quality of target object speech extraction can be improved in comparison with a different speech extraction method. In addition, speech recognition of the target object is performed by using both the first speech extraction model and the second speech extraction model. In other words, the first speech extraction model and the second speech extraction model are fused based on various configurations to perform the target object speech extraction, so that characteristics of different speech extraction models can be effectively used. For example, a characteristic of the first speech extraction model including the converter block and a characteristic of the second speech extraction model configured to extract the target object mask vector of the target object can be effectively used, thereby further improving performance accuracy of the target object speech extraction.

### BRIEF DESCRIPTION OF THE DRAWINGS

Embodiments of this disclosure are described with reference to the accompanying drawings, for illustration of the foregoing and other objectives, features, and advantages of embodiments of this disclosure. The accompanying drawings are provided to facilitate the understanding of the embodiments of this disclosure and constitute a part of the specification, and are configured to explain this disclosure together with the embodiments of this disclosure without limiting this disclosure. In the accompanying drawings, same reference numerals usually represent same components or operations.

FIG. 1 is a diagram of a scenario of a speech extraction system according to an embodiment of this disclosure.

FIG. 2 is a flowchart of a speech extraction method according to an embodiment of this disclosure.

FIG. 3 is a schematic diagram of a structure of a first speech extraction model according to an embodiment of this disclosure.

FIG. 4A is a schematic diagram of a first fusion configuration of a first speech extraction model and a second speech extraction model according to an embodiment of this disclosure.

FIG. 4B is a schematic diagram of a second fusion configuration of a first speech extraction model and a second speech extraction model according to an embodiment of this disclosure.

FIG. 4C is a schematic diagram of a third fusion configuration of a first speech extraction model and a second speech extraction model according to an embodiment of this disclosure.

FIG. 5 is a schematic diagram of a structure of a speech extraction apparatus according to an embodiment of this disclosure.

FIG. 6 is a schematic diagram of an architecture of an electronic device according to an embodiment of this disclosure.

### DESCRIPTION OF EMBODIMENTS

The following will describe the technical solutions in embodiments of this disclosure with reference to the accompanying drawings in this disclosure. The described embodiments are merely non-limiting examples of this disclosure. All other embodiments obtained by a person of ordinary skill in the art based on the embodiments of this disclosure shall fall within the scope of this disclosure. Other embodiments are within the scope of this disclosure.

As shown in embodiments of this disclosure, unless an exceptional case is prompted in the context, terms such as “a”, “one”, “an”, and “the” do not specifically refer to a singular, and may also include a plural. “First”, “second”, and similar terms used in the embodiments of this disclosure do not represent any sequence, quantity, or importance, but are only used to distinguish different components. Similarly, “include”, “comprise”, and similar terms mean that an element or object appearing before the term includes an element or object appearing after the term and an equivalent thereof, but does not exclude another element or object. “Connection”, “connected”, and similar terms are not limited to a physical or mechanical connection, but may include an electrical connection, regardless of a direct or indirect connection.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In embodiments of this disclosure, the term “module” or “unit” refers to a computer program having a predetermined function or a part of a computer program, and works together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In addition, a flowchart is used in this disclosure to illustrate operations performed by a system according to one or more non-limiting embodiments of this disclosure. The foregoing or following operations are not necessarily performed precisely in order. On the contrary, various operations may be processed in a reverse order or simultaneously. Meanwhile, other operations may be added to these processes, or one or several operations may be removed from these processes.

In the speech technologies, voiceprint recognition is to distinguish an unknown sound by analyzing features of one or more speech signals. Target speaker extraction (TSE), also referred to as target object speech extraction, is a classification of the voiceprint recognition. The target object speech extraction is also referred to as personalized speech enhancement or personalized noise suppression, and is to extract speech of a target object from a mixed speech signal with noise and an interfering speech by using registered speech information of the target object. Herein, the target object refers to an interested speaker or a specified speaker.

In this disclosure, for clarity and simplicity of the description, a mixed speech signal including one or more speech signals delivered by one or more objects or speakers may also be referred to as a mixed speech signal including the one or more objects, or as the one or more objects existing in the mixed speech signal. Also, for clarity and simplicity of the description, a duration of a speech signal delivered by an object or speaker may be referred to in this disclosure as a speech duration of the object or speaker.

In some examples, a target object speech extraction model may use a pre-trained speaker feature extraction model to generate a target object feature vector based on a reference speech signal from the target object, and further extract a speech signal of the target object from the mixed speech signal based on the target object feature vector. However, many other target object speech extraction models are for mixed speech in which a quantity of speakers is limited (for example, less than or equal to 3) and the target object exists, and a ratio (which may be referred to as an overlap rate) of speech duration of the target object in the mixed speech to total speech duration is high. For example, the ratio of the speech duration of the target object in the mixed speech to the total speech duration is greater than a preset ratio. During processing of a mixed speech signal in which a quantity of speakers is large (for example, greater than a preset quantity threshold, where the preset quantity threshold may be 5), or the target object does not exist (which may be referred to as absence of the target object), or the overlap rate of the target object is low (for example, the ratio of the speech duration of the target object in the mixed speech to the total speech duration is less than the preset ratio), the extraction results may be unsatisfactory.

To resolve the foregoing problems, one or more embodiments of this disclosure provide a speech extraction model (that is, a target object speech extraction model), which can effectively extract a high-quality speech signal of the target object from a mixed speech signal in which a plurality of speakers exist, the target object is absent, and the overlap rate of the target object is low.

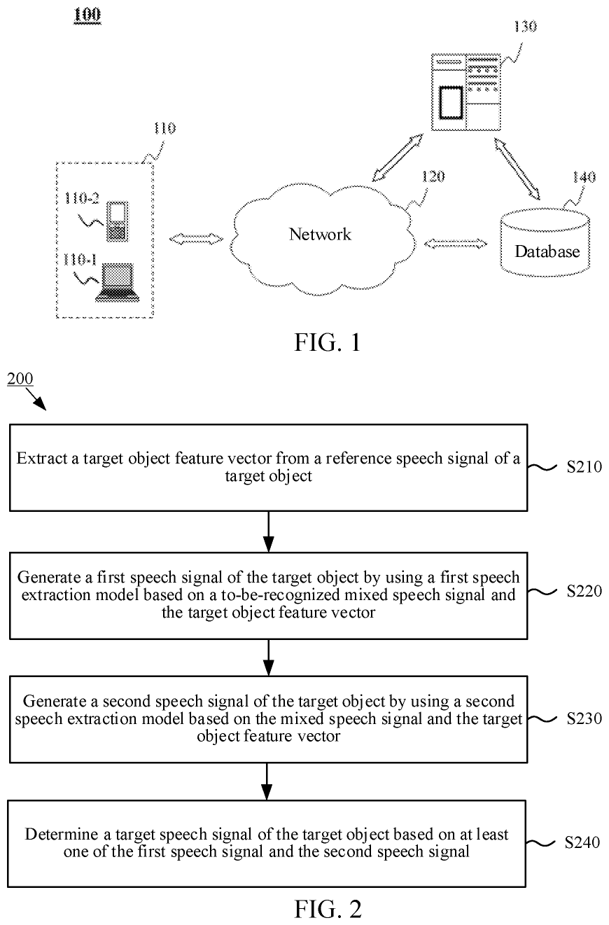

FIG. 1 is a diagram of a scenario of a speech extraction system according to an embodiment of this disclosure. As shown in FIG. 1, a speech extraction system 100 may include a user terminal 110, a network 120, a server 130, and a database 140.

The user terminal 110 may be, for example, a computer 110-1 and a mobile phone 110-2 shown in FIG. 1. In some examples, the user terminal 110 may be any other type of electronic device that can perform data processing, and may include, but is not limited to, a fixed terminal such as a desktop computer or a smart television, a mobile terminal such as a smart phone, a tablet computer, a portable computer, or a handheld device, or any combination thereof. This is not limited in this disclosure.

The user terminal 110 in one or more embodiments may be configured to: receive a mixed speech signal, and generate a speech signal of a target object by using a speech extraction method provided in the disclosure. In some embodiments, the speech extraction method provided in the disclosure may be performed by using processing circuitry (e.g., one or more processors) of the user terminal 110. In some implementations, the user terminal 110 may perform the speech extraction method described in the disclosure by using a built-in application program of the user terminal. In some other implementations, the user terminal 110 may perform the speech extraction method described in the disclosure by invoking an application program stored outside the user terminal.

In some other embodiments, the user terminal 110 sends a received to-be-processed mixed speech signal to the server 130 via the network 120, and the server 130 performs the speech extraction method. In some implementations, the server 130 may perform the speech extraction method by using a built-in application program of the server. In some other implementations, the server 130 may perform the speech extraction method by invoking an application program stored outside the server.

The network 120 may be a single network or a combination of at least two different networks. For example, the network 120 may include, but is not limited to, one or any combination of a local area network, a wide area network, a public network, and a private network. The server 130 may be a standalone server, or may be a server cluster or distributed system including a plurality of physical servers, or may be a cloud server providing cloud computing services such as a cloud service, a cloud database, cloud computing, a cloud function, cloud storage, a network service, cloud communication, a middleware service, a domain name service, a security service, and a positioning service, as well as big data and an artificial intelligence platform. This is not limited in this disclosure.

The database 140 may correspond to a device having a storage function. In some examples, the database 140 is configured to store various data used, generated, and outputted during work of the user terminal 110 and the server 130. The database 140 may be local or remote. The database 140 may include various memories, such as a random-access memory (RAM) and a read-only memory (ROM). The storage devices mentioned above are merely some examples, and the storage device that can be used in the system is not limited thereto. The database 140 may be connected to or communicate with the server 130 or a part of the server 130 through the network 120, or be directly connected to or communicate with the server 130, or a combination of the foregoing two manners.

A speech extraction method of an embodiment of this disclosure is described below with reference to FIG. 2. FIG. 2 is a flowchart of a speech extraction method 200 according to an embodiment of this disclosure. The speech extraction method may be a target object speech extraction method. As described above, the speech extraction method 200 may be performed by a user terminal or a server. This is not limited in this disclosure.

Operation S210: Extract a target object feature vector from a reference speech signal of a target object.

The target object may be any object that can make or deliver a speech. For example, the target object may be a target speaker, an artificial intelligence device, or a speech device. When the target object is the target speaker, a reference speech signal from the target speaker may be obtained, and the target object feature vector is extracted from the reference speech signal. When the target object is the artificial intelligence device, speech made by the artificial intelligence device may be collected and used as a reference speech signal. When the target object is the speech device, speech made by the speech device may be collected and used as a reference speech signal, and then the target object feature vector is extracted from the reference speech signal.

The reference speech signal may correspond to a signal including only a speech (or utterance) delivered by the target object. In some examples, the reference speech signal may include one or more of the following types: a pure speech signal, prior information, and an auxiliary microphone signal. For the pure speech signal, in some application scenarios, pure speech records of the target speaker may be already available, and these records may serve as the reference speech signals to help recognize and extract a target speech signal in a noisy environment. For the prior information, in some cases, the reference speech signal may be prior information based on the target speaker, for example, particular features (such as a formant frequency and timbre) of speech of the target speaker. This information may help a speech extraction model to better focus on the target speech signal of the target object. For the auxiliary microphone signal, when a microphone array is used to collect speech signals, the reference speech signal may come from a particular microphone or a combination of a plurality of microphones that correspond to a sound source position and direction, where the reference speech signal may be usable during extraction of the target speech signal of the target object.

In some examples, the reference speech signal may be a speech signal with a length of 10 seconds from the target object. The reference speech signal provides a clue to extract the target object speech from a mixed speech signal. A length of the reference speech signal is not limited in this disclosure. According to one or more requirements in various implementation examples, the reference speech signal may be a speech signal with any length.

In some embodiments, several methods may be implemented for extracting the reference speech signal. In one extraction method, the reference speech signal refers to reference speech signals of a plurality of target speech, where the reference speech signals are obtained by processing, by using algorithms such as sound source positioning, beam forming, and wavelet decomposition, speech signals captured by a microphone array. These reference speech signals are used as auxiliary information in an independent component analysis (ICA) algorithm, to more effectively extract the target speech signal of the target object from background noise and interference sound. In another extraction method, the reference speech signal may be a time-frequency feature obtained by extracting a multi-channel speech signal and a distance feature and an inter-channel feature that are obtained through mapping processing. These features may be considered as a type of the reference speech signal, and configured to assist determining and extracting the target speech signal of the target object.

After the reference speech signal of the target object is obtained, the target object feature vector may be generated based on the reference speech signal from the target object. The target object feature vector may be referred to as a target object embedding vector, and may correspond to a vector that can represent an audio feature of the target object. In some embodiments, a speaker encoder may be constructed and trained to extract a feature vector from a speech signal, or a pre-trained speaker encoder model may be used to generate a feature vector. In some examples, the speaker encoder model is a type of a speech signal encoder. In some examples, the speech signal encoder is a type of a device or an algorithm configured to convert an analog speech signal or a digital speech signal into a digital format suitable for storage or transmission. For example, a ResNet34 based on a residual neural network may serve as the speaker encoder model. This is not limited in this disclosure.

Operation S220: Generate a first speech signal of the target object by using a first speech extraction model based on a to-be-recognized mixed speech signal and the target object feature vector. In some examples, a target object activity probability of the target object is generated through a combination of a speaker encoder and a first speech extraction model based on a mixed speech signal and the target object feature vector. In some examples, the first speech extraction model includes at least one converter block, and the converter block includes a multi-head self-attention layer and a gated recurrent unit layer.

In some examples, the first speech signal of the target object may be extracted by using the first speech extraction model based on at least the target object feature vector and the mixed speech signal. Herein, the mixed speech signal refers to mixed audio including a target object signal, an interfering speaker signal, a background noise signal, and the like. In some examples, the mixed speech signal includes a speech signal segment in which a plurality of speakers exist and a speech signal segment in which the target object is absent, and a ratio (that is, an overlap rate) of speech duration of the target object to total speech duration of the mixed speech signal varies. In other words, in the mixed speech signal, ratios of speech duration of different speech signal segments of the target object to the total speech duration of the mixed speech signal are uncorrelated with each other, and speech signal segments having low, intermediate, and high overlap rates of the target object may be included simultaneously, thereby adapting to various collection scenarios for the mixed speech signal. For example, in a mixed speech signal with a length of 10 minutes, a speech signal segment from the 0^{th} minute (i.e., the beginning of the 10-minute signal) to the 1^{st} minute is a first speech signal segment including the target object, a speech signal segment from the 1^{st} minute to the 2^{nd} minute is a second speech signal segment in which the target object is absent, a speech signal segment from the 2^{nd} minute to the 6^{th} minute is a third speech signal segment including the target object, a speech signal segment from the 6^{th} minute to the 8^{th} minute is a fourth speech signal segment in which the target object is absent, and a speech signal segment from the 8^{th} minute to the 10^{th} minute is a fifth speech signal segment including the target object. Therefore, it can be learned that the first speech signal segment, the third speech signal segment, and the fifth speech signal segment are all speech signal segments including the target object. However, lengths of the three speech signal segments in this example are different. Therefore, ratios of the three speech signal segments to the total speech duration of the mixed speech signal are different from each other and are also uncorrelated with each other.

For example, the mixed speech signal Y may be represented by the following formula (1):

$$Y = S + I + N \qquad ( 1 )$$

Y represents the mixed speech signal; S represents the target object signal; I represents the interfering speaker signal; and N represents the background noise signal. In some examples, the target object speech extraction method in this disclosure focuses on resolving single-channel target object speech extraction, that is, the mixed speech signal Y comes from a single audio acquisition channel. However, the speech extraction method in this disclosure may also be applied to multi-channel target object speech extraction when being properly modified, provided that there is no contradiction. In the following, the single-channel target object speech extraction is used as a non-limiting example to describe various embodiments of this disclosure.

The first speech signal of the target object may be generated by using the first speech extraction model. In other words, the first speech signal of the target object may be generated by using the first speech extraction model based on the to-be-recognized mixed speech signal and the target object feature vector. Herein, the first speech extraction model includes at least one converter block, and the converter block includes a multi-head self-attention layer and a gated recurrent unit layer.

Operation S230: Generate a second speech signal of the target object by using a second speech extraction model based on the mixed speech signal and the target object feature vector. In some examples, an extracted speech signal is generated through a second speech extraction model based on the mixed speech signal and the target object feature vector, the second speech extraction model being configured to extract a target object mask vector of the target object based on the target object feature vector and to obtain the extracted speech signal based on the target object mask vector.

In some examples, the second speech extraction model is configured to extract a target object mask vector of the target object from an input signal (e.g., the mixed speech signal in some examples or a processed signal based on the target object activity probability the mixed speech signal). In some examples, the first speech signal and the second speech signal of the target object may be respectively obtained by using the first speech extraction model and the second speech extraction model that are based on different principles. The first speech extraction model and the second speech extraction model may be combined with each other in various different forms, to generate the first speech signal, the second speech signal, and a final target speech signal of the target object. Details are further described below.

In some examples, the first speech extraction model may be implemented based on a target object voice activity detection (TSVAD) model configured to detect a target object activity probability. The model may predict, with the help of the target object feature vector, a probability that the target object appears in each time frame in the mixed speech signal or a processed mixed speech signal, and the probability is referred to as the target object activity probability. In some examples, the target object activity probability represents a probability of presence of a component speech signal of the target object in an input speech signal of the first speech extraction model in each time frame. In some examples, the target object mask vector indicates a set of locations in an input speech signal of the second speech extraction model that corresponds to a component speech signal of the target object.

In some examples, the processed mixed speech signal refers to a mixed speech signal that has undergone other target object speech extraction, or refers to a mixed speech signal obtained after an original mixed speech signal (that is, an originally collected mixed speech signal) is processed in at least one of the following processing manners: pre-emphasis processing, endpoint detection, denoising processing, speech enhancement processing, frame division processing, normalization processing, mute detection and deletion processing, feature conversion processing, speech rate conversion processing, pitch and energy normalization processing, nonlinear distortion removal processing, and the like.

The pre-emphasis processing is a technology of improving a speech signal characteristic in frequency domain, and is mainly to enhance a high-frequency part of speech, so that the high-frequency part is more easily analyzed and recognized during subsequent processing. In other words, for the pre-emphasis processing, because a high-frequency part of the original mixed speech signal usually attenuates faster, the high-frequency part may be enhanced through the pre-emphasis processing, so that a feature of the mixed speech signal is more easily extracted during the subsequent processing. The endpoint detection refers to determining a start point and an end point of the speech signal, to eliminate a silence part and improve processing efficiency. The denoising processing refers to using various algorithms (such as wiener filtering, wavelet transform, and spectral subtraction) to reduce background noise. The speech enhancement processing refers to improving clarity and intelligibility of the speech by using an algorithm (such as echo cancellation, noise suppression, and nonlinear processing). The frame division processing refers to segmenting the speech signal into short time frames. For example, a window function such as a Hamming window or a Hann window may be used to reduce an edge effect. The normalization processing refers to adjusting an amplitude of the speech signal to a uniform scale, to facilitate comparison and further processing. The mute detection and deletion processing refers to recognizing and removing a mute part in the speech signal, to reduce unnecessary processing and storage. The feature conversion processing refers to converting the speech signal from time domain into frequency domain or another domain (such as mel-frequency cepstral coefficients), to extract a more abstract feature. The speech rate conversion processing refers to adjusting a playback speed of the speech as required without changing a tone of the speech. The pitch and energy normalization processing refers to normalizing a pitch and energy of the speech signal, to reduce differences between different speakers. The nonlinear distortion removal processing refers to reducing or eliminating nonlinear distortion generated in a transmission or processing process.

The first speech extraction model in some examples may include at least one converter block, and the at least one converter block may include neural network layers such as the multi-head self-attention layer and the gated recurrent unit (GRU) layer. The multi-head self-attention layer is configured to enable the first speech extraction model to simultaneously process information at different locations of an audio sequence in the mixed speech signal or in the processed mixed speech signal, thereby improving a spatial expression capability of the model, and improving a training speed of the model. The multi-head self-attention layer processes input data based on a multi-head self-attention mechanism. The multi-head self-attention mechanism is a key mechanism in a transformer model, and allows the model to learn information in different subspaces in parallel, thereby improving an expression capability and flexibility of the model. The multi-head self-attention mechanism splits self-attention into a plurality of “heads”, and each head has an own weight matrix, thereby performing self-attention operations in a plurality of subspaces in parallel. Operations of a working principle of the multi-head self-attention mechanism may be summarized as follows: First, input segmentation is performed, and an input sequence may be segmented into a plurality of “heads”, and each head receives a subset of the sequence. Then, linear transformation is performed on the input sequence, and the linear transformation may be performed on each head, to obtain a query vector, a key vector, and a value vector respectively. Then, an attention score is calculated based on a result of the linear transformation, e.g., for the query vector of each head, attention scores of the query vector and all key vectors are calculated, where these scores represent association between the query vector and the key vectors. Then, the attention score of each head is normalized by using a softmax function, to obtain probability distribution. Finally, weighted summation is performed on the value vector by using the probability distribution obtained by using the softmax function, to obtain an output vector of each head, and output vectors of all the heads are combined, to obtain a final output.

The gated recurrent unit layer is configured to enable the first speech extraction model to better capture the following information: a dependency relationship between time frames in which time step distances are greater than a preset distance threshold in a time frame sequence of the mixed speech signal or the processed mixed speech signal, thereby effectively resolving problems such as gradient explosion and gradient attenuation in long-term memory and back propagation in a neural network.

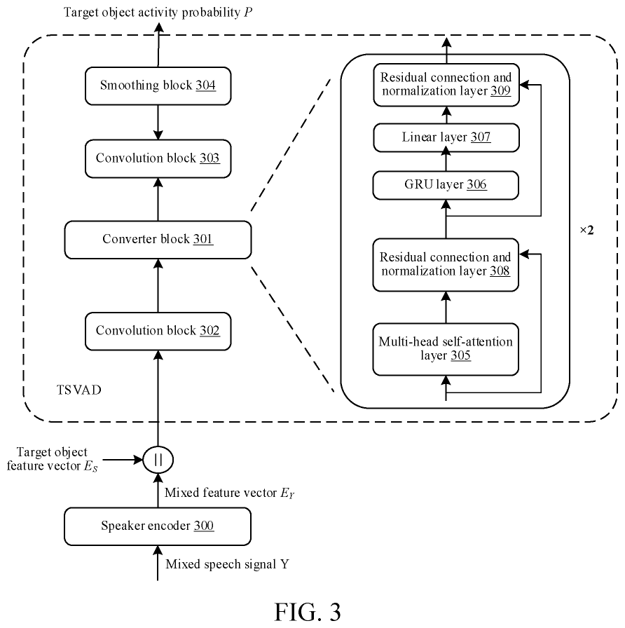

FIG. 3 is a schematic diagram of a structure of a first speech extraction model according to an embodiment of this disclosure. A TSVAD model is used as an example of the first speech extraction model for description. As shown in FIG. 3, in addition to a converter block 301, the first speech extraction model may further include at least one convolution block (a convolution block 302 and a convolution block 303 shown in FIG. 3), a smoothing block 304 for post-processing, and the like. In addition to a multi-head self-attention layer 305 and a GRU layer 306, each converter block may further include a linear layer 307 and at least one residual connection and normalization layer (for example, a residual connection and normalization layer 308 and a residual connection and normalization layer 309 shown in FIG. 3). The linear layer 307 may be configured to introduce a linear component, and the residual connection and normalization layer may be configured to integrate information, enhancing model stability, and accelerating model convergence. In the example in FIG. 3, an example in which the first speech extraction model has two converter blocks 301 is used for description. However, this embodiment of this disclosure is not limited thereto. The first speech extraction model may alternatively include any quantity of converter blocks according to an actual requirement. Similarly, quantities of blocks and layers shown in FIG. 3 are all examples, and do not constitute any limitation to this embodiment of this disclosure.

A mixed speech signal Y or a processed mixed speech signal Y′ may be divided into frame vectors [y₁, y₂, . . . , yₜ] (where t represents a quantity of frames) by using a framing module. Subsequently, as shown in FIG. 3, a speaker encoder 300 may be used to extract a mixed feature vector E_{Y}=[E_{y1}, E_{y2}, . . . , E_{yt}] from the mixed speech signal or the processed mixed speech signal divided into the frame vectors. The mixed feature vector E_{Y} and a target object feature vector E_{S} that is extracted from a reference speech signal of a target object are connected, and are inputted into a TSVAD model. After processed performed by the at least one convolution block, the at least one converter block, and the smoothing block, a target object activity probability P=[P_{y1}, P_{y2}, . . . , P_{yt}] is outputted. This process may be represented by the following formula (2):

$$P = TSVAD ( {E}_{Y} , {E}_{S} ) \qquad ( 2 )$$

P represents the target object activity probability, E_{Y} represents the mixed feature vector, E_{S} represents the target object feature vector, and TSVAD (·) represents a target object activity detection function, which generates the target object activity probability based on the mixed feature vector E_{Y} and the target object feature vector E_{S}.

After the target object activity probability is obtained, the target object activity probability may be converted into a target object activity label in a binary form based on a predetermined threshold, for example, a target object activity label with a value of 0 or 1. For example, when the target object activity label is 1, it may indicate that a current time frame is a speech signal of the target object. Otherwise, when the target object activity label is 0, it may indicate that the current time frame is not the speech signal of the target object. In some examples, the predetermined threshold may be obtained based on model training, determined based on an empirical parameter, or determined based on a probability distribution feature. This is not limited in this disclosure. Subsequently, the mixed speech signal or the processed mixed speech signal may be filtered by using the target object activity label. For example, a time frame in which a target object activity label is 0 is filtered out, and only a time frame in which a target object activity label is 1 is retained, so that the speech signal of the target object can be obtained, that is, a first speech signal.

In the first speech extraction model in some examples, the at least one converter block including the multi-head self-attention layer and the gated recurrent unit layer is introduced, so that performance of target object speech extraction can be improved. An example in which the TSVAD model is used as the first speech extraction model is used for description. The following Table 1 shows results of an ablation experiment performed on the TSVAD model, where TSVAD represents the TSVAD model including the at least one converter block in this embodiment of this disclosure, and TSVAD* represents removing the converter block from the TSVAD model in this embodiment of this disclosure, or replacing the converter block with another neural network module such as a long short-term memory (LSTM) network. Other experimental conditions are the same. In Table 1, DER represents a target object diarization error rate, INT represents an energy difference between the mixed speech signal and an extracted target speech signal of the target object. Therefore, a smaller value of the DER and a larger value of the INT represent better performance of the target object speech extraction. It can be learned from Table 1 that, in comparison with a TSVAD* model in which the converter block is removed or replaced, DER of the TSVAD model is smaller and INT of the TSVAD model is larger in this embodiment of this disclosure, which indicates that performance of the TSVAD model in this embodiment of this disclosure on the target object speech extraction is better. It indicates that introduction of the at least one converter block plays an important role in improving the performance of the target object speech extraction.

TABLE 1
Ablation experiment results of the TSVAD model

| | DER | INT |
|---|---|---|
| TSVAD | 43.1 | 26.9 |
| TSVAD* | 49.3 | 23.7 |

In this embodiment of this disclosure, the second speech extraction model may be a target speaker mask extraction (TSE) model configured to perform the following processing: extracting a target object mask vector from the mixed speech signal or the processed mixed speech signal. For example, the processed mixed speech signal refers to a mixed speech signal that has undergone other target object speech extraction processing. The target object mask vector may indicate a location of the speech signal of the target object in the mixed speech signal or the processed mixed speech signal. For example, the target object mask vector may be a vector having the same dimension as a vector of the mixed speech signal and including 0 and 1. If an element value is 1, it indicates that an element at the same location of a vector of the mixed speech signal is the speech signal of the target object. If an element value is 0, it indicates that an element at the same location of a vector of the mixed speech signal is not the speech signal of the target object. The process of extracting the target object mask vector from the mixed speech signal or the processed mixed speech signal may be represented by the following formula (3):

$$M = TSE ( Y , {E}_{S} ) \qquad ( 3 )$$

M represents the target object mask vector, Y represents the mixed speech signal, E_{S} represents the target object feature vector, and TSE (·) represents a target object mask extraction function, which generates the target object mask vector based on the mixed speech signal and the target object feature vector E_{S}. A second speech signal retaining only the speech signal of the target object may be generated based on the target object mask vector and the mixed speech signal or the processed mixed speech signal. For example, the second speech signal may be generated by multiplying the target object mask vector by the mixed speech signal or the processed mixed speech signal.

Operation S240: Determine the target speech signal of the target object based on at least one of the first speech signal and the second speech signal. In some examples, a target speech signal corresponding to the target object for audio output is obtained based on the target object activity probability and at least one of the extracted speech signal and the mixed speech signal.

In some examples, the first speech extraction model and the second speech extraction model may be fused based on different configurations to generate the target speech signal of the target object. For example, the fusion process may be represented by the following formula (4):

$${S}^{′} = F ( Y , M , P ) \qquad ( 4 )$$

S′ represents the extracted target speech signal of the target object, Y represents the mixed speech signal, M represents the target object mask vector, P represents the target object activity probability, and F(·) represents a fusion function, which can generate the target speech signal based on the mixed speech signal Y, the target object mask vector M, and the target object activity probability P.

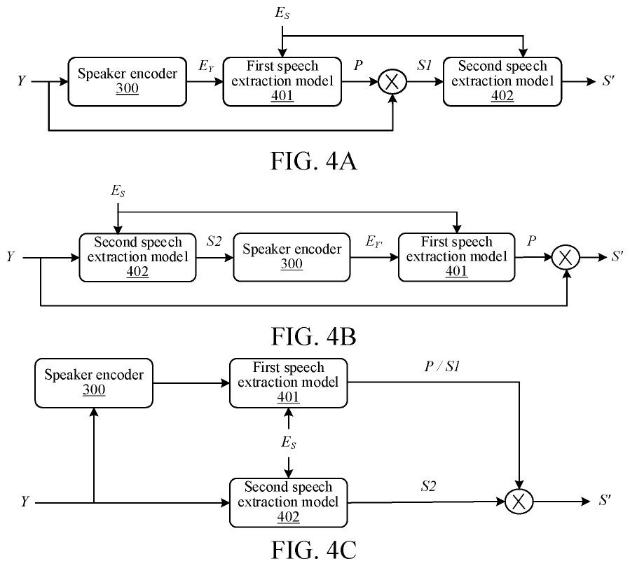

Different fusion configurations of the first speech extraction model and the second speech extraction model in the embodiments of this disclosure are described below with reference to FIG. 4A to FIG. 4C. FIG. 4A shows a first fusion configuration of a first speech extraction model and a second speech extraction model according to an embodiment of this disclosure, FIG. 4B shows a second fusion configuration of a first speech extraction model and a second speech extraction model according to an embodiment of this disclosure, and FIG. 4C shows a third fusion configuration of a first speech extraction model and a second speech extraction model according to an embodiment of this disclosure.

In some examples, the configuration in FIG. 4A corresponds to providing the mixed speech signal to the speaker encoder to obtain the target object activity probability from the first speech extraction model, generating a first speech signal based on the target object activity probability and the mixed speech signal, providing the first speech signal to the second speech extraction model as input to obtain the extracted speech signal, and determining the extracted speech signal as the target speech signal. In some examples, the generating the first speech signal includes converting the target object activity probability into a target object activity label in a binary form based on a predetermined threshold, and filtering time frames in the mixed speech signal by using the target object activity label, to obtain the first speech signal.

In an example, output of the first speech extraction model may be inputted to the second speech extraction model, and the final target speech signal of the target object is generated by using the second speech extraction model. As shown in FIG. 4A, a first mixed feature vector may be first generated based on the mixed speech signal Y. For example, a speaker encoder 300 shown in FIG. 4A may be used to generate a first mixed feature vector E_{Y} based on the mixed speech signal Y. To be specific, the mixed speech signal Y is inputted into the speaker encoder 300, and the speaker encoder 300 encodes the mixed speech signal Y to obtain the first mixed feature vector E_{Y}. Subsequently, a first speech extraction model 401 generates a target object activity probability P based on the first mixed feature vector E_{Y} and the target object feature vector E_{S} generated based on the reference speech signal from the target object in the foregoing embodiment. Further, a first speech signal S1 of the target object may be generated based on the target object activity probability P and the mixed speech signal Y. For example, the target object activity probability may be converted into the target object activity label in the binary form based on the predetermined threshold. Then, the target object activity label is used to filter the mixed speech signal to generate the first speech signal S1.

So far, initial target object speech extraction is performed on the mixed speech signal Y by using the first speech extraction model 401. Therefore, in this case, the first speech signal S1 may also be referred to as a processed mixed speech signal. For more accurate target object speech extraction, the first speech signal S1 may be inputted into a second speech extraction model 402. The second speech extraction model 402 may generate a second speech signal based on the first speech signal S1 and the target object feature vector E_{S}, and the second speech signal is used as an extracted target speech signal S′ of the target object.

In this example, the target object activity label configured to filter the mixed speech signal may be generated by using a low predetermined threshold (for example, the predetermined threshold may belong to a first threshold range, and a maximum value of the first threshold range is less than a particular maximum threshold), thereby minimizing a risk of incorrectly filtering out the speech signal of the target object. Further target object speech extraction is performed in combination of the second speech extraction model, so that a high-quality speech signal of the target object can be effectively extracted.

In another example, output of the second speech extraction model 402 may be inputted into the first speech extraction model 401, and the final target speech signal of the target object is generated by using the first speech extraction model 401. As shown in FIG. 4B, the second speech extraction model 402 may be used to generate a target object mask vector M based on the mixed speech signal Y and the target object feature vector E_{S} generated based on the reference speech signal from the target object in the foregoing embodiment, and then a second speech signal S2 is generated based on the target object mask vector M and the mixed speech signal Y.

In some examples, the configuration in FIG. 4B corresponds to providing the mixed speech signal to the second speech extraction model as input to obtain the extracted speech signal, providing the extracted speech signal to the speaker encoder to obtain the target object activity probability from the first speech extraction model, and determining the target speech signal based on the target object activity probability and the mixed speech signal. In some examples, the determining the target speech signal includes converting the target object activity probability into a target object activity label in a binary form based on a predetermined threshold, and filtering time frames in the mixed speech signal by using the target object activity label, to obtain the target speech signal.

In some examples, the initial target object speech extraction is performed on the mixed speech signal Y by using the second speech extraction model 402. Therefore, in this case, the second speech signal S2 may also be referred to as a processed mixed speech signal. For more accurate target object speech extraction, a second mixed feature vector may be generated based on the second speech signal S2. For example, a speaker encoder 300 shown in FIG. 4B is used to generate a second mixed feature vector E_{Y} based on the second speech signal S2. Subsequently, the first speech extraction model 401 may generate the target object activity probability P based on the second mixed feature vector E_{Y} and the target object feature vector E_{S}. Then, the first speech signal is generated based on the target object activity probability P and the mixed speech signal Y, and the first speech signal is used as the extracted target speech signal S′ of the target object.

In some examples, an initial speech signal with a low overlap rate is first extracted from the mixed speech signal by using the second speech extraction model 402, and then the target speech signal of the target object is further accurately extracted by using the first speech extraction model 401.

In another example, the first speech extraction model 401 and the second speech extraction model 402 may be connected in parallel. As shown in FIG. 4C, the first mixed feature vector may be first generated based on the mixed speech signal Y. For example, the speaker encoder 300 shown in FIG. 4A may be used to generate the first mixed feature vector E_{Y} based on the mixed speech signal Y. Subsequently, the first speech extraction model 401 generates the target object activity probability P based on the first mixed feature vector E_{Y} and the target object feature vector E_{S} generated based on the reference speech signal from the target object in the foregoing embodiment. Further, the first speech signal S1 of the target object may be generated based on the target object activity probability P and the mixed speech signal Y. According to another aspect, the second speech extraction model 402 may generate the target object mask vector M based on the mixed speech signal Y and the target object feature vector E_{S} generated based on the reference speech signal from the target object in the foregoing embodiment, and then the second speech signal S2 is generated based on the target object mask vector M and the mixed speech signal Y. Subsequently, the target speech signal of the target object may be generated based on the first speech signal S1 (or the target object activity probability P without mixing with mixed speech signal Y) and the second speech signal S2. For example, as shown in FIG. 4C, the extracted target speech signal S′ of the target object may be generated by multiplying the first speech signal S1 by the second speech signal S2.

In some examples, the configuration in FIG. 4C corresponds to providing the mixed speech signal to the speaker encoder to obtain the target object activity probability from the first speech extraction model, generating a first speech signal based on the target object activity probability and the mixed speech signal, providing the mixed speech signal to the second speech extraction model as input to obtain the extracted speech signal, and determining the target speech signal based on multiplication of the first speech signal and the extracted speech signal.

In some examples, the configuration in FIG. 4C corresponds to providing the mixed speech signal to the speaker encoder to obtain the target object activity probability from the first speech extraction model, providing the mixed speech signal to the second speech extraction model as input to obtain the extracted speech signal, and determining the target speech signal based on the target object activity probability and the extracted speech signal. In some examples, the determining the target speech signal includes converting the target object activity probability into a target object activity label in a binary form based on a predetermined threshold and filtering time frames in the extracted speech signal by using the target object activity label, to obtain the target speech signal.

In some examples, the first speech extraction model 401 and the second speech extraction model 402 are connected to each other in parallel, and interaction between the two models is small, so that dependency on auxiliary information is reduced, and efficiency of the target object speech extraction can be improved.

The different fusion configurations of the first speech extraction model and the second speech extraction model are described above with reference to FIG. 4A to FIG. 4C. The fusion configurations and specific modules, input parameters, and output parameters shown in FIG. 4A to FIG. 4C are merely used as an example or for description, and this embodiment of this disclosure is limited thereto. For example, the first speech extraction model and the second speech extraction model may alternatively be fused in another proper mode.

When the speech extraction method in this embodiment of this disclosure is used, the at least one converter block including the multi-head self-attention sub-layer and the gated recurrent sub-layer is introduced into the first speech extraction model such as the TSVAD model, so that quality of target object speech extraction can be improved in comparison with a different target object speech extraction method. In addition, the first speech extraction model and the second speech extraction model are fused in different configurations to perform the target object speech extraction, so that characteristics of different speech extraction models can be effectively used, thereby further improving performance of the target object speech extraction. The target object speech extraction method in this embodiment of this disclosure is particularly applicable to processing a mixed speech signal in which a plurality of speakers exist, the target object is absent, and an overlap rate of the target object is low or variable, thereby implementing accurate and efficient target object speech extraction.

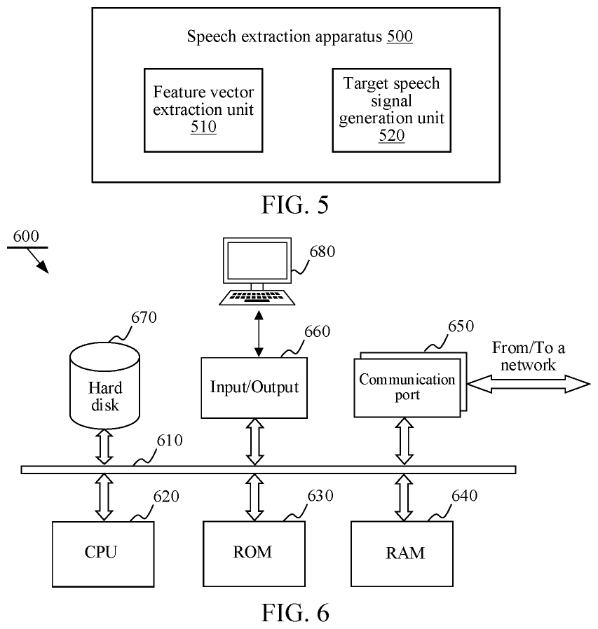

A speech extraction apparatus of a target object according to an embodiment of this disclosure is described below with reference to FIG. 5. FIG. 5 is a schematic diagram of a structure of a speech extraction apparatus 500 of the target object according to an embodiment of this disclosure. As shown in FIG. 5, the speech extraction apparatus 500 includes a feature vector extraction unit 510 and a target speech signal generation unit 520. In addition to the two units, the apparatus 500 may further include other related components. However, because the components are unrelated to content of this embodiment of this disclosure, detailed descriptions of specific content of the components are omitted herein. In addition, details of some functions of the speech extraction apparatus 500 are similar to details of operations of the speech extraction method 200 described with reference to FIG. 2. Therefore, for brevity, repeated descriptions of some content are omitted herein. The speech extraction apparatus 500 in this embodiment of this disclosure may be implemented as a terminal or a server, as described above with reference to FIG. 1.

The feature vector extraction unit 510 is configured to extract a target object feature vector from a reference speech signal of the target object; In this embodiment of this disclosure, the feature vector extraction unit 510 may construct and train a speaker encoder to extract a feature vector from a speech signal, or may generate a feature vector by using a pre-trained speaker encoder model. For example, a ResNet34 based on a residual neural network may be used. This is not limited in this disclosure. The target speech signal generation unit 520 is configured to generate a first speech signal of the target object by using a first speech extraction model based on a to-be-recognized mixed speech signal and the target object feature vector, the first speech extraction model including at least one converter block, and the converter block including a multi-head self-attention layer and a gated recurrent unit layer; generate a second speech signal of the target object by using a second speech extraction model based on the mixed speech signal and the target object feature vector, the second speech extraction model being configured to extract a target object mask vector of the target object from the mixed speech signal; and determine a target speech signal of the target object based on at least one of the first speech signal and the second speech signal.

In some embodiments, the target speech signal generation unit 520 is further configured to extract a first mixed feature vector from the mixed speech signal; generate a target object activity probability by using the first speech extraction model based on the target object feature vector and the first mixed feature vector, the target object activity probability representing a probability that each time frame in the mixed speech signal is a speech signal of the target object; and generate the first speech signal based on the target object activity probability and the mixed speech signal.

In some embodiments, the target speech signal generation unit 520 is further configured to convert the target object activity probability into a target object activity label in a binary form based on a predetermined threshold; and filter time frames in the mixed speech signal by using the target object activity label, to obtain the first speech signal.

In some embodiments, the target speech signal generation unit 520 is further configured to obtain the first speech signal generated based on the mixed speech signal and the target object feature vector; and generate the second speech signal by using the second speech extraction model based on the target object feature vector and the first speech signal.

In some embodiments, the target speech signal generation unit 520 is further configured to determine the second speech signal as the target speech signal of the target object.

In some embodiments, the target speech signal generation unit 520 is further configured to multiply the first speech signal by the second speech signal, to obtain the target speech signal of the target object.

In some embodiments, the target speech signal generation unit 520 is further configured to generate the target object mask vector by using the second speech extraction model based on the target object feature vector and the mixed speech signal, the target object mask vector indicating a location of the speech signal of the target object in the mixed speech signal; and generate the second speech signal based on the target object mask vector and the mixed speech signal.

In some embodiments, the target speech signal generation unit 520 is further configured to generate a second mixed feature vector based on the second speech signal; generate the target object activity probability based on the target object feature vector and the second mixed feature vector, the target object activity probability representing the probability that each time frame in the mixed speech signal is the speech signal of the target object; and generate the first speech signal based on the target object activity probability and the mixed speech signal.

In some embodiments, the target speech signal generation unit 520 is further configured to determine the first speech signal as the target speech signal of the target object.

In some embodiments, the first speech extraction model further includes at least one convolution block; and the at least one converter block further includes a linear layer and at least one residual connection and normalization layer.

In some embodiments, the first speech extraction model is a target object voice activity detection model configured to detect the target object activity probability, and the second speech extraction model is a target object mask extraction model configured to extract the target object mask vector. The target object activity probability indicates the probability that each time frame in the mixed speech signal is the speech signal of the target object. The target object mask vector indicates the location of the speech signal of the target object in the mixed speech signal.

In some embodiments, the mixed speech signal includes a speech signal segment in which a plurality of objects exist and a speech signal segment in which the target object is absent. In the mixed speech signal, ratios of speech duration of different speech signal segments of the target object to total speech duration of the mixed speech signal are uncorrelated with each other.

In this embodiment of this disclosure, the first speech extraction model may be implemented based on a target object voice activity detection (TSVAD) model configured to detect the target object activity probability. The model may predict, with the help of the target object feature vector, a probability that the target object appears in each time frame in the mixed speech signal or a processed mixed speech signal, and the probability is referred to as the target object activity probability. For example, the processed mixed speech signal refers to a mixed speech signal that has undergone other target object speech extraction processing. The first speech extraction model in this embodiment of this disclosure includes the at least one converter block, and the converter block may include neural network layers such as the multi-head self-attention layer or the gated recurrent unit layer. Herein, the multi-head self-attention layer is configured to enable the first speech extraction model to simultaneously process information at different locations of an audio sequence in the mixed speech signal or in the processed mixed speech signal, thereby improving a spatial expression capability of the model, and improving a training speed of the model. The gated recurrent unit layer is configured to enable the first speech extraction model to better capture a dependency relationship between time frames in which time step distances are large in a time frame sequence of the mixed speech signal or the processed mixed speech signal, thereby effectively resolving problems such as gradient explosion and gradient attenuation in long-term memory and back propagation in a neural network. After the target object activity probability is obtained, the target object activity probability may be converted into the target object activity label in the binary form based on the predetermined threshold, for example, a target object activity label with a value of 0 or 1. For example, when the target object activity label is 1, it may indicate that a current time frame is the speech signal of the target object. Otherwise, when the target object activity label is 0, it may indicate that the current time frame is not the speech signal of the target object. Herein, for example, the predetermined threshold may be obtained based on model training, determined based on an empirical parameter, or determined based on a probability distribution feature. This is not limited in this disclosure. Subsequently, the mixed speech signal or the processed mixed speech signal may be filtered by using the target object activity label. For example, a time frame in which a target object activity label is 0 is removed, and only a time frame in which a target object activity label is 1 is retained, so that the speech signal of the target object can be obtained, that is, a first speech signal. In the first speech extraction model in this embodiment of this disclosure, the at least one converter block including the multi-head self-attention layer and the gated recurrent unit layer is introduced, so that performance of target object speech extraction can be improved.

In this embodiment of this disclosure, the second speech extraction model may be the target object mask extraction model configured to extract the target object mask vector from the mixed speech signal or the processed mixed speech signal. For example, the processed mixed speech signal refers to the mixed speech signal that has undergone other target object speech extraction processing. The target object mask vector may indicate the location of the speech signal of the target object in the mixed speech signal or the processed mixed speech signal. For example, the target object mask vector may be a vector having the same dimension as a vector of the mixed speech signal and including 0 and 1. If an element value is 1, it indicates that an element at the same location of a vector of the mixed speech signal is the speech signal of the target object. If an element value is 0, it indicates that an element at the same location of a vector of the mixed speech signal is not the speech signal of the target object.

When the speech extraction apparatus of the target object in this embodiment of this disclosure is used, the at least one converter block including the multi-head self-attention sub-layer and the gated recurrent sub-layer is introduced into the first speech extraction model such as the TSVAD model, so that quality of target object speech extraction can be improved in comparison with a different target object speech extraction method. In addition, the first speech extraction model and the second speech extraction model are fused based on different configurations to perform the target object speech extraction, so that characteristics of different speech extraction models can be effectively used, thereby further improving performance of the target object speech extraction. The speech extraction apparatus of the target object in this embodiment of this disclosure is particularly applicable to processing a mixed speech signal in which a plurality of speakers exist, the target object is absent, and an overlap rate of the target object is low or variable, thereby implementing accurately and efficient target object speech extraction.

In addition, an electronic device (for example, the electronic device may be a target object speech extraction device) further provided in an embodiment of this disclosure may also be implemented with the help of an architecture of an electronic device shown in FIG. 6. FIG. 6 is a schematic diagram of an architecture of an electronic device according to an embodiment of this disclosure. As shown in FIG. 6, an electronic device 600 may include a bus 610, processing circuitry (e.g., one or more CPUs 620), a read-only memory (ROM) 630, a random access memory (RAM) 640, a communication port 650 connected to a network, an input/output component 660, a hard disk 670, and the like. A storage device in the electronic device 600, for example, the ROM 630 or the hard disk 670, or a non-transitory computer-readable storage medium in one or more other forms may store various data or files used by a computer for processing and communication and program instructions executed by the CPU. The electronic device 600 may further include a user interface 680. The architecture shown in FIG. 6 is merely a non-limiting example. When different electronic devices are implemented, one or more components in the electronic device shown in FIG. 6 may be omitted according to an actual requirement. The electronic device in this disclosure may be configured to perform the speech extraction methods in the foregoing embodiments of this disclosure, or be configured to implement the speech extraction apparatuses in the foregoing embodiment of disclosure.

At least one embodiment of this disclosure may be implemented as a non-transitory computer-readable storage medium, and the non-transitory computer-readable storage medium in this embodiment of this disclosure has computer-readable instructions stored therein. When the computer-readable instructions are executed by processing circuitry (e.g., a processor), the speech extraction method according to this disclosure, as described with reference to the above figures, can be performed. The computer-readable storage medium includes, but is not limited to, for example, at least one of a volatile memory and a non-volatile memory. For example, the volatile memory may include at least one of a random access memory and a cache. The non-volatile memory may be configured as a non-transitory computer readable storage medium to store instructions as described in one or more embodiments of the present disclosure, and may include, for example, a read-only memory, a hard disk, or a flash memory.

At least one embodiment of this disclosure provides a computer program product or a computer program. The computer program product or the computer program includes computer-readable instructions, and the computer-readable instructions are stored in a non-transitory computer-readable storage medium. Processing circuitry (such as a processor) of an electronic device may read the computer-readable instructions from the non-transitory computer-readable storage medium, and the processor may execute the computer-readable instructions, to enable the electronic device to perform the speech extraction methods described in the foregoing embodiments.

A program part in the technologies may be considered as a “product” or an “article” that exists in a form of executable code and related data, which is participated in or implemented through the non-transitory computer-readable storage medium. A non-transitory storage medium may include an internal memory or a memory used by any computer, processor, or similar device or related module, for example, various semiconductor memories, tape drives, disk drives, or any similar device that can provide a storage function for software.

This disclosure uses particular terms to describe this embodiment of this disclosure. Terms such as “first/second embodiment,” “an embodiment,” and “some embodiments” refer to a feature, a structure, or a characteristic related to at least one embodiment of the disclosure. Therefore, repeated references in this specification to “an embodiment,” “one embodiment,” or “an alternative embodiment” at different positions do not necessarily refer to the same embodiment. In addition, some features, structures, or characteristics may be combined in proper manners to form one or more embodiments of this disclosure.

In addition, a person skilled in the art may understand that, various aspects of the embodiments of this disclosure may be illustrated and described by using several types or situations having patentability, including any new and useful process, machine, product, or combination of matter, or any new and useful improvement to the process, machine, product, or combination of matter. Correspondingly, various aspects of the embodiments of this disclosure may be performed entirely by hardware, may be performed entirely by software (including firmware, regular software, microcode, and the like), or may be performed by a combination of the hardware and the software. The foregoing hardware or software may be referred to as a “data block”, a “module”, an “engine”, a “unit”, a “component”, or a “system”. In addition, various aspects of the embodiments of this disclosure may be represented as a computer product located in one or more computer-readable media, and the product includes computer-readable program code.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Unless otherwise defined, all terms (including technical and scientific terms) used herein have the same meanings as commonly understood by a person of ordinary skill in the art to which the embodiments of this disclosure. Terms such as those defined in a dictionary are to be interpreted as having meanings consistent with their meanings in the context of the related art.

The foregoing description of the embodiments of this disclosure is provided for purposes of illustration and is not intended to be limiting. Although several embodiments of this disclosure are described, a person skilled in the art will readily appreciate that numerous modifications can be made to the embodiments without departing from the teachings and advantages of the embodiments of this disclosure. Therefore, all such modifications are intended to fall within the scope of the present disclosure. The foregoing descriptions are merely non-limiting examples of the embodiments of this disclosure, and are not to be construed as a limitation to the embodiments disclosed, and modifications to the disclosed embodiments and other embodiments are intended to fall within the scope of the disclosure.

What is claimed is:

1. A speech extraction method, comprising:
extracting a target object feature vector from a reference speech signal of a target object;
generating, by processing circuitry, a target object activity probability of the target object through a combination of a speaker encoder and a first speech extraction model based on a mixed speech signal and the target object feature vector, the first speech extraction model including at least one converter block, and the converter block including a multi-head self-attention layer and a gated recurrent unit layer;
generating, by the processing circuitry, an extracted speech signal through a second speech extraction model based on the mixed speech signal and the target object feature vector, the second speech extraction model being configured to extract a target object mask vector of the target object based on the target object feature vector and to obtain the extracted speech signal based on the target object mask vector; and
obtaining a target speech signal corresponding to the target object for audio output based on the target object activity probability and at least one of the extracted speech signal and the mixed speech signal.

2. The method according to claim 1, wherein the obtaining the target speech signal comprises:
providing the mixed speech signal to the speaker encoder to obtain the target object activity probability from the first speech extraction model;
generating a first speech signal based on the target object activity probability and the mixed speech signal;
providing the first speech signal to the second speech extraction model as input to obtain the extracted speech signal; and
determining the extracted speech signal as the target speech signal.

3. The method according to claim 2, wherein the generating the first speech signal comprises:
converting the target object activity probability into a target object activity label in a binary form based on a predetermined threshold; and
filtering time frames in the mixed speech signal by using the target object activity label, to obtain the first speech signal.

4. The method according to claim 1, wherein the obtaining the target speech signal comprises:
providing the mixed speech signal to the speaker encoder to obtain the target object activity probability from the first speech extraction model;
generating a first speech signal based on the target object activity probability and the mixed speech signal;
providing the mixed speech signal to the second speech extraction model as input to obtain the extracted speech signal; and
determining the target speech signal based on multiplication of the first speech signal and the extracted speech signal.

5. The method according to claim 1, wherein the obtaining the target speech signal comprises:
providing the mixed speech signal to the speaker encoder to obtain the target object activity probability from the first speech extraction model;
providing the mixed speech signal to the second speech extraction model as input to obtain the extracted speech signal; and
determining the target speech signal based on the target object activity probability and the extracted speech signal.

6. The method according to claim 5, wherein the determining the target speech signal comprises:
converting the target object activity probability into a target object activity label in a binary form based on a predetermined threshold; and
filtering time frames in the extracted speech signal by using the target object activity label, to obtain the target speech signal.

7. The method according to claim 1, wherein the obtaining the target speech signal comprises:
providing the mixed speech signal to the second speech extraction model as input to obtain the extracted speech signal;
providing the extracted speech signal to the speaker encoder to obtain the target object activity probability from the first speech extraction model; and
determining the target speech signal based on the target object activity probability and the mixed speech signal.

8. The method according to claim 7, wherein the determining the target speech signal comprises:
converting the target object activity probability into a target object activity label in a binary form based on a predetermined threshold; and
filtering time frames in the mixed speech signal by using the target object activity label, to obtain the target speech signal.

9. The method according to claim 1, wherein the first speech extraction model further comprises at least one convolution block, the at least one converter block including a linear layer and at least one residual connection and normalization layer.

10. The method according to claim 1, wherein
the first speech extraction model includes a target object voice activity detection model configured to generate the target object activity probability,
the second speech extraction model includes a target object mask extraction model configured to extract the target object mask vector,
the target object activity probability represents a probability of presence of a component speech signal of the target object in an input speech signal of the first speech extraction model in each time frame, and
the target object mask vector indicates a set of locations in an input speech signal of the second speech extraction model that corresponds to a component speech signal of the target object.

11. The method according to claim 1, wherein
the mixed speech signal includes a speech signal segment in which component speech signals of a plurality of objects exist and a speech signal segment in which no component speech signal of the target object exists, and
ratios of speech durations of different speech signal segments that include respective component signals of the target object to a total speech duration of the mixed speech signal are uncorrelated with each other.

12. A speech extraction apparatus, comprising:
processing circuitry configured to:
extract a target object feature vector from a reference speech signal of a target object;
generate a target object activity probability of the target object through a combination of a speaker encoder and a first speech extraction model based on a mixed speech signal and the target object feature vector, the first speech extraction model including at least one converter block, and the converter block including a multi-head self-attention layer and a gated recurrent unit layer;
generate an extracted speech signal through a second speech extraction model based on the mixed speech signal and the target object feature vector, the second speech extraction model being configured to extract a target object mask vector of the target object based on the target object feature vector and to obtain the extracted speech signal based on the target object mask vector; and
obtain a target speech signal corresponding to the target object for audio output based on the target object activity probability and at least one of the extracted speech signal and the mixed speech signal.

13. The apparatus according to claim 12, wherein the processing circuitry is configured to:
provide the mixed speech signal to the speaker encoder to obtain the target object activity probability from the first speech extraction model;
generate a first speech signal based on the target object activity probability and the mixed speech signal;
provide the first speech signal to the second speech extraction model as input to obtain the extracted speech signal; and
determine the extracted speech signal as the target speech signal.

14. The apparatus according to claim 13, wherein the processing circuitry is configured to:
convert the target object activity probability into a target object activity label in a binary form based on a predetermined threshold; and
filter time frames in the mixed speech signal by using the target object activity label, to obtain the first speech signal.

15. The apparatus according to claim 12, wherein the processing circuitry is configured to:
provide the mixed speech signal to the speaker encoder to obtain the target object activity probability from the first speech extraction model;
generate a first speech signal based on the target object activity probability and the mixed speech signal;
provide the mixed speech signal to the second speech extraction model as input to obtain the extracted speech signal; and
determine the target speech signal based on multiplication of the first speech signal and the extracted speech signal.

16. The apparatus according to claim 12, wherein the processing circuitry is configured to:
provide the mixed speech signal to the speaker encoder to obtain the target object activity probability from the first speech extraction model;
provide the mixed speech signal to the second speech extraction model as input to obtain the extracted speech signal; and
determine the target speech signal based on the target object activity probability and the extracted speech signal.

17. The apparatus according to claim 16, wherein the processing circuitry is configured to:
convert the target object activity probability into a target object activity label in a binary form based on a predetermined threshold; and
filter time frames in the extracted speech signal by using the target object activity label, to obtain the target speech signal.

18. The apparatus according to claim 12, wherein the processing circuitry is configured to:
provide the mixed speech signal to the second speech extraction model as input to obtain the extracted speech signal;
provide the extracted speech signal to the speaker encoder to obtain the target object activity probability from the first speech extraction model; and
determine the target speech signal based on the target object activity probability and the mixed speech signal.

19. The apparatus according to claim 18, wherein the processing circuitry is configured to:
convert the target object activity probability into a target object activity label in a binary form based on a predetermined threshold; and
filter time frames in the mixed speech signal by using the target object activity label, to obtain the target speech signal.

20. A non-transitory computer-readable storage medium storing instructions, which when executed by a processor, cause the processor to perform a speech extraction method comprising:
extracting a target object feature vector from a reference speech signal of a target object;
generating a target object activity probability of the target object through a combination of a speaker encoder and a first speech extraction model based on a mixed speech signal and the target object feature vector, the first speech extraction model including at least one converter block, and the converter block including a multi-head self-attention layer and a gated recurrent unit layer;
generating an extracted speech signal through a second speech extraction model based on the mixed speech signal and the target object feature vector, the second speech extraction model being configured to extract a target object mask vector of the target object based on the target object feature vector and to obtain the extracted speech signal based on the target object mask vector; and
obtaining a target speech signal corresponding to the target object for audio output based on the target object activity probability and at least one of the extracted speech signal and the mixed speech signal.
